(19) United States
(12) Patent Application Publication
(10) Pub. No.: US 2025/0208741 A1
(43) Pub. Date: Jun. 26, 2025

(54) VARIABLE MAGNETIC COUPLING TOUCH SENSORS

(71) Applicant: Allegro MicroSystems, LLC, Manchester, NH (US)

(72) Inventors: Paul A. David, Bow, NH (US); William P. Taylor, Amherst, NH (US)

(73) Assignee: Allegro MicroSystems, LLC, Manchester, NH (US)

(21) Appl. No.: 18/492,987

(22) Filed: Dec. 26, 2023

(51) Int. Cl. G06F 3/046; G06F 3/041

(52) U.S. Cl. CPC G06F 3/046; G06F 3/0414

(57) ABSTRACT

Variable magnetic coupling touch sensors are described which have a deformable layer with ferromagnetic material distributed throughout its volume, and one or more magnetic field sensing elements that can detect changes in a magnetic field due to deformation of the deformable layer. The ferromagnetic material can include soft ferromagnetic material in some embodiments. The ferromagnetic material can include hard ferromagnetic material in some embodiments. In some embodiments, e.g., ones having soft ferromagnetic material(s), one or more transmitting elements/antennas, e.g., coils, may be utilized to produce an applied magnetic field. Monitoring circuitry can detect changes in a magnetic field or magnetic coupling due to deformation of the deformable layer and produce a corresponding output signal indicative of the deformation of the deformable layer. Magnitude, direction, and/or location of the force or pressure causing the deformation can be determined from the output signal.

### BACKGROUND

Touch sensors typically provide an input mechanism for a device or system through tactile or haptic functionality, such as for example, by touching a sensor surface of the sensor device. Different types of touch sensors may require touch input to be provided by different mechanisms. For example, capacitive touch sensors are typically responsive to a touch by a body part, such as a finger or a conductive stylus specifically designed for capacitive sensors. Resistive touch sensors are responsive to pressure provided by relatively rigid materials that are able to depress the touch surface with sufficient force. Such touch sensors can possess limitations arising from the mechanisms used for tactile input and/or from the related methods of manufacture.

### SUMMARY

One general aspect of the present disclosure includes variable magnetic coupling touch sensors utilizing soft (referring to magnetic property) ferromagnetic material(s). An example magnetic touch sensor can include: one or more transmitting coils disposed on a substrate and configured to transmit a signal; one or more magnetic field sensing elements disposed on the substrate and configured to receive the signal from the one or more transmitting coils; a deformable layer containing soft ferromagnetic material, where the deformable layer is adjacent to the one or more magnetic field sensing elements, with the deformable layer being configured to facilitate magnetic coupling between the one or more transmitting coils and the one or more magnetic field sensing elements, and with the deformable layer being mechanically compliant and configured to undergo a deformation in response to an applied force; and detection circuitry connected to the one or more magnetic field sensing elements and configured to detect a change in the signal in response to the deformation of the deformable layer, with the detection circuitry being configured to produce an output signal indicative of the deformation of the deformable layer. Other embodiments of this aspect include corresponding computer systems, apparatus, and computer programs recorded on one or more computer storage devices, each configured to perform actions for detecting deformation of the deformable layer, producing a related output signal or signals, and/or determining a physical or temporal quantity or range based on the signal(s).

Implementations may include one or more of the following features. The magnetic touch sensor may include a semiconductor die, e.g., disposed on the substrate. An integrated circuit in the semiconductor die may include the detection circuitry. The substrate may include a printed circuit board (PCB). The soft ferromagnetic material can be dispersed in the deformable layer. The deformable layer can have a plurality of regions and the soft ferromagnetic material can be dispersed with different respective concentrations in the plurality of regions. The output signal can be indicative of a location associated with the applied force. The output signal can be indicative of a direction associated with the applied force. The output signal can be indicative of a magnitude associated with the applied force. The output signal can be indicative of a time associated with the applied force or pressure. The output signal can be indicative of a temperature associated with the applied force. The output signal can be indicative of a pressure applied to the deformable layer. The output signal can be indicative of a displacement of the deformable layer. The output signal can be indicative of a location associated with the displacement of the deformable layer.

The one or more transmitting coils may be disposed adjacent to one or more magnetic field sensing elements. The one or more magnetic field sensing elements may include a first plurality of receiving coils. The one or more transmitting coils may include a first transmitting coil larger in size than an individual receiving coil of the first plurality of receiving coils, and the first plurality of receiving coils can be disposed on the substrate within an area of the first transmitting coil. The magnetic touch sensor may include a second plurality of receiving coils disposed around the area of the first transmitting coil. The magnetic touch sensor may include a magnetic core disposed adjacent the one or more transmitting coils and/or the first plurality of receiving coils to facilitate magnetic coupling between the one or more transmitting coils and the first plurality of receiving coils. The one or more magnetic field sensing elements may include a plurality of Hall effect elements. The one or more magnetic field sensing elements may include a plurality of magnetoresistance (MR) elements. The plurality of MR elements may include giant magnetoresistance (GMR) elements. The plurality of MR elements may include tunneling magnetoresistance (TMR) elements. The deformable layer may include polyimide. The deformable layer may include benzocyclobutene (BCB). The deformable layer may include silicone gel. The magnetic touch sensor may include a protective layer disposed between (i) the one or more transmitting coils and/or one or more magnetic field sensing elements, and (ii) the deformable layer. The protective layer may include Parylene. The soft ferromagnetic material may include ferrite particles. Implementations of the described techniques may include hardware, a method or process, or computer software on a computer-accessible medium.

Another general aspect includes variable magnetic coupling touch sensors utilizing hard ferromagnetic material(s). An example magnetic touch sensor can include: one or more magnetic field sensing elements disposed on a substrate; a deformable layer disposed adjacent to the one or more magnetic field sensing elements, with the deformable layer including a hard ferromagnetic material, where the deformable layer is mechanically compliant and configured to undergo a deformation in response to an applied force, and where the deformable layer is configured to produce a changing magnetic field in response to the deformation; and detection circuitry connected to the one or more magnetic field sensing elements and configured to detect the changing magnetic field at the one or more magnetic field sensing elements and produce an output signal, where the output signal is indicative of the deformation of the deformable layer. Other embodiments of this aspect can include corresponding computer systems, apparatus, and computer programs recorded on one or more computer storage devices, each configured to perform the actions for detecting deformation of the deformable layer, producing a related output signal or signals, and/or determining a physical or temporal quantity or range based on the signal(s).

Implementations may include one or more of the following features. The substrate of the magnetic touch sensor may include a semiconductor die, a.k.a., an integrated circuit (IC) die. The semiconductor die may include an integrated circuit (IC) including the detection circuitry. The substrate may include a printed circuit board (PCB). The hard ferromagnetic material can be dispersed in the deformable layer. The deformable layer may have a plurality of regions with the hard ferromagnetic material being dispersed with different respective concentrations in the plurality of regions. The output signal can be indicative of a location associated with the applied force. The output signal can be indicative of a direction associated with the applied force. The output signal can be indicative of a magnitude associated with the applied force. The output signal can be indicative of a temperature and/or time associated with the applied force or pressure. The output signal can be indicative of a pressure applied to the deformable layer. The output signal can be indicative of a displacement of the deformable layer. The output signal can be indicative of a location associated with the displacement of the deformable layer.

The one or more magnetic field sensing elements may include a plurality of receiving coils. The one or more magnetic field sensing elements may include a plurality of Hall effect elements. The one or more magnetic field sensing elements may include a plurality of magnetoresistance (MR) elements. The plurality of MR elements may include giant magnetoresistance (GMR) elements. The plurality of MR elements may include tunneling magnetoresistance (TMR) elements. The deformable layer may include polyimide. The deformable layer may include benzocyclobutene (BCB). The deformable layer may include silicone gel. The magnetic touch sensor may include a protective layer disposed between the one or more magnetic field sensing elements and the deformable layer. The protective layer may include Parylene. The hard ferromagnetic material may include ferrite particles. Implementations of the described techniques may include hardware, a method or process, or computer software on a computer-accessible medium.

Another general aspect includes a method of making a variable magnetic coupling touch sensor. The method can include: providing one or more magnetic field sensing elements on a substrate; forming a deformable layer adjacent the one or more magnetic field sensing elements, where the deformable layer includes ferromagnetic material, with the deformable layer being mechanically compliant and configured to undergo a deformation in response to an applied force, and with the deformable layer being configured to produce a changing magnetic field in response to the deformation; and providing detection circuitry configured to detect the changing magnetic field and produce an output signal indicative of the deformation of the deformable layer. Other embodiments of this aspect include corresponding computer systems, apparatus, and computer programs recorded on one or more computer storage devices, each configured to perform the actions of the method(s).

Implementations may include one or more of the following features. The ferromagnetic material used for the magnetic touch sensor can include a hard (referring to magnetic property) ferromagnetic material, in some embodiments. The one or more transmitting antennas can be configured to transmit a signal, and the one or more magnetic field sensing elements can be configured to receive the signal. The ferromagnetic material used for the magnetic touch sensor may include a soft ferromagnetic material, in some embodiments. The protective layer can be configured to protect the one or more magnetic field sensing elements. The one or more magnetic field sensing elements may include a plurality of Hall effect elements. The one or more magnetic field sensing elements may include a plurality of magnetoresistance (MR) elements. The plurality of MR elements may include giant magnetoresistance (GMR) elements. The plurality of MR elements may include tunneling magnetoresistance (TMR) elements. Implementations of the described techniques may include hardware, a method or process, or computer software on a computer-accessible medium.

The features and advantages described herein are not all-inclusive; many additional features and advantages will be apparent to one of ordinary skill in the art in view of the drawings, specification, and claims. Moreover, it should be noted that the language used in the specification has been selected principally for readability and instructional purposes, and not to limit in any way the scope of the present disclosure, which is susceptible of many embodiments. What follows is illustrative, but not exhaustive, of the scope of the present disclosure.

### BRIEF DESCRIPTION OF THE DRAWINGS

The manner and process of making and using the disclosed examples and embodiments of the present disclose may be appreciated by reference to the figures of the accompanying drawings. In the figures like reference characters refer to like components, parts, elements, or steps/actions; however, similar components, parts, elements, and steps/actions may be referenced by different reference characters in different figures. It should be appreciated that the components and structures illustrated in the figures are not necessarily to scale, emphasis instead being placed upon illustrating the principles of the concepts described herein. Furthermore, examples and embodiments are illustrated by way of example and not limitation in the figures, in which:

FIGS. 1A-1F show an example variable magnetic coupling touch sensor system utilizing soft ferromagnetic material (“soft” referring to magnetism property) dispersed in a deformable layer and a transmit coil used in conjunction with a receive coil, with corresponding steps of fabrication, in accordance with an embodiment of the present disclosure.

FIGS. 2A-2F show an example variable magnetic coupling touch sensor system utilizing soft ferromagnetic material and a transmit coil used in conjunction with a magnetic field sensing element, with corresponding steps of fabrication, in accordance with an embodiment of the present disclosure;

FIGS. 3A-3B show magnetic coupling for an example variable magnetic touch sensor undergoing change due to compression of a binder layer containing soft ferromagnetic material, in accordance with the present disclosure;

FIGS. 4A-4C show further embodiments having different configurations of receive coils and inclusion of a magnetic core for one embodiment, in accordance with the present disclosure;

FIGS. 5A-5B show specific density of magnetic particles in a binder layer of an example variable magnetic coupling touch sensor undergoing changes due to compression, in accordance with the present disclosure;

FIGS. 6A-6F show an example variable magnetic coupling touch sensor system utilizing hard ferromagnetic material used in conjunction with a receive coil, with corresponding steps of fabrication, in accordance with an embodiment of the present disclosure;

FIG. 7 is a diagram showing steps in an example method of making variable magnetic coupling touch sensors, in accordance with the present disclosure; and

FIG. 8 is a schematic diagram of an example computer system that can perform all or at least a portion of methods, algorithms, and processing, in accordance with the present disclosure.

### DETAILED DESCRIPTION

The features and advantages described herein are not all-inclusive; many additional features and advantages will be apparent to one of ordinary skill in the art in view of the drawings, specification, and claims. Moreover, it should be noted that the language used in the specification has been selected principally for readability and instructional purposes, and not to limit in any way the scope of the inventive subject matter. The subject technology is susceptible of many embodiments. What follows is illustrative, but not exhaustive, of the scope of the subject technology.

As used herein, the term “magnetic field sensor” is used to describe a circuit that uses a magnetic field sensing element, generally in combination with other circuits. As used herein, the term “magnetic field sensing element” is used to describe a variety of electronic elements that can sense a magnetic field. The magnetic-field sensing element can be, but is not limited to, a Hall effect element, a magnetoresistance element, a magnetotransistor or an inductive coil. As is known, there are different types of Hall effect elements, for example, a planar Hall effect element, a vertical Hall effect element, and a Circular Vertical Hall (CVH) effect element.

As is also known, there are different types of magnetoresistance elements, for example, a semiconductor magnetoresistance element such as Indium Antimonide (InSb), a giant magnetoresistance (GMR) element, an anisotropic magnetoresistance element (AMR), a tunneling magnetoresistance (TMR) element, and a magnetic tunnel junction (MTJ).

The magnetic field sensing element may be a single element or, alternatively, may include two or more magnetic field sensing elements arranged in various configurations, e.g., a half bridge or full (Wheatstone) bridge. Depending on the device type and other application requirements, the magnetic field sensing element may be a device made of a type IV semiconductor material such as Silicon (Si) or Germanium (Ge), or a type III-V semiconductor material like Gallium-Arsenide (GaAs) or an Indium compound, e.g., Indium-Antimonide (InSb).

Aspects of the present disclosure are directed to and include systems, structures, circuits, and methods utilizing ferromagnetic material (e.g., particles) in a deformable layer (e.g., of binder material) near to a sensor. The deformation of the deformable layer, laden with the ferromagnetic material, can be detected by the sensor and used to detect pressure, location, deflection (displacement), applied force, direction of applied force, and/or temperature, etc.

An aspect of the present disclosure includes variable magnetic coupling touch sensors having a deformable layer with ferromagnetic material (e.g., particles) distributed throughout its volume, and one or more magnetic field sensing elements that can detect changes in a magnetic field due to deformation of the deformable layer. The magnetic particles can be or include one or more soft ferromagnetic materials, in some embodiments. The magnetic particles can be or include one or more hard ferromagnetic materials, in some embodiments. In some embodiments, e.g., ones having soft ferromagnetic material(s), one or more transmitting elements/antennas, e.g., coils, may be utilized to produce an applied magnetic field, as explained in further detail below.

In some embodiments, the deformable layer can include a deformable binder that is filled (laden) with soft ferromagnetic material. A transmitting system (e.g., including an antenna or coil) can be used to apply a magnetic field to the deformable layer and a detection system, e.g., a one or more magnetic field sensing elements resident in or on a PCB or silicon circuit. The detection system can be used to detect changes in the detected magnetic field due to deformation of the deformable layer (e.g., binder). For embodiments utilizing a silicon circuit, the deformable binder can be placed directly on the silicon or can be deposited on an encapsulated silicon die. Some embodiments can include a relatively large sending (transmitting) coil in conjunction with one or more receiving coils. For example, a single large coil can be used with multiple small receiving coils to detect changes in magnetic coupling, allowing for detection of both location of the changes (in magnetic coupling) and magnitude of the coupling. In some examples, a large transmitting coil can surround the smaller receiving coils. In some examples, the large coil can be surrounded by the small coils. In some examples, some small coils may surround the large coil while other small coils may be located within the area of the large coil. In some examples, the small coils may be positioned in patterns or desired locations (not necessarily according to a pattern) designed/optimized for the type of detection desired (e.g., pressure, force, location, etc.). In other embodiments, multiple sending coils may be used instead of a single one. In some embodiments, an antenna of various shapes/geometries, may be used as a transmitting element instead of one having a coil configuration.

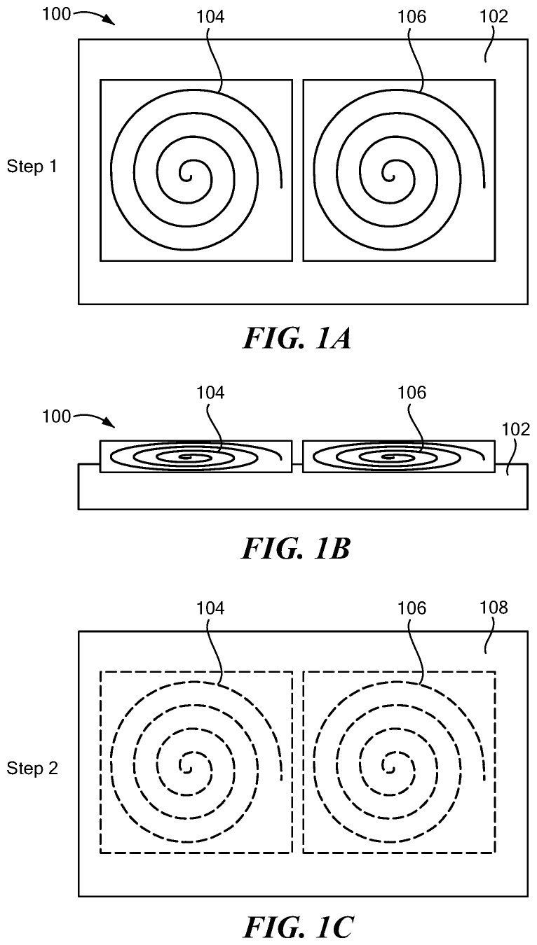

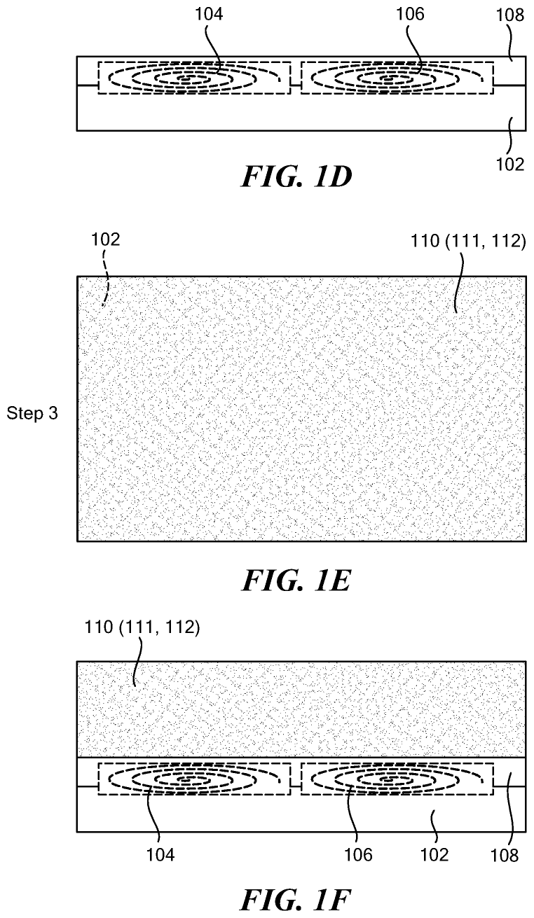

FIGS. 1A-1F show an example variable magnetic coupling touch sensor system 100 utilizing soft ferromagnetic material (“soft” referring to magnetism property) dispersed in a deformable layer and a transmit coil used in conjunction with a receive coil, with corresponding steps of fabrication, in accordance with an embodiment of the present disclosure. FIGS. 1A, 1C, and 1E show top views of successive steps (Steps 1-3) of fabrication of system 100 and FIGS. 1B, 1D, and 1F show corresponding side views, respectively.

For Step 1, shown in FIGS. 1A-1B, a base system or substrate 102 (e.g., a silicon die, or other substrate), can have a transmission (transmitter or send) coil 104 and a receiver coil 106 placed on it. The coils 104, 106 can be located adjacent to, e.g., placed on top of, a monitoring circuit/circuitry (not shown) that is designed (configured) to monitor the coupling of the coils.

For Step 2, shown in FIGS. 1C-1D, a protective layer 108 can be applied on top of the coils 104, 106 and substrate 102 to, e.g., prevent possible harmful interactions of materials. In some examples, Parylene (e.g., Parylene N, Parylene C, Parylene D, or Parylene HT) can be used for protective layer 108. Parylene is the trade name for poly-(para-xylylene), a class of semicrystalline, hydrophobic polymers which can be deposited as thin, conformal, pinhole-free films using, e.g., chemical vapor deposition (CVD). Other suitable material(s) can be used for protective layer 108 within the scope of the present disclosure.

For Step 3, shown in FIGS. 1E-1F, a mechanically compliant (deformable) material/layer 110 can be applied to the system 100 structure shown at Step 2. The deformable material/layer 110 can include a soft ferromagnetic material 111 (e.g., ferrite or the like) that is bound in mechanically compliant material 112 (e.g., a binder). Any suitable material may be used for deformable layer 110, e.g., polyimide, benzocyclobutene (BCB), or silicone gel, etc.

In operation of system 100, an applied force causes deformation of deformable layer 110, which increases the density of soft ferromagnetic material in a corresponding region of deformable layer, altering the magnetic coupling between coils 104, 106. The monitoring circuit/circuitry can detect the change in magnetic coupling for determining one or more physical conditions or parameters associated with an applied force, e.g., a magnitude, direction, time (duration) and/or location of or associated with the applied force and produce an output signal indicative of the change in magnetic coupling, as explained in further detail below. In some embodiments, system 100 can determine a temperature associated with an applied force, applied pressure, or deflection (displacement) of the deformable layer 110, e.g., due to thermal expansion or contraction of the deformable layer 110 or an object or layer touching/contacting the deformable layer 110. The monitoring circuit/circuitry or other circuit(s)/circuitry can receive and utilize the output signal and from it determine, e.g., a magnitude, temperature, time (duration), direction and/or location associated with the applied force or applied pressure.

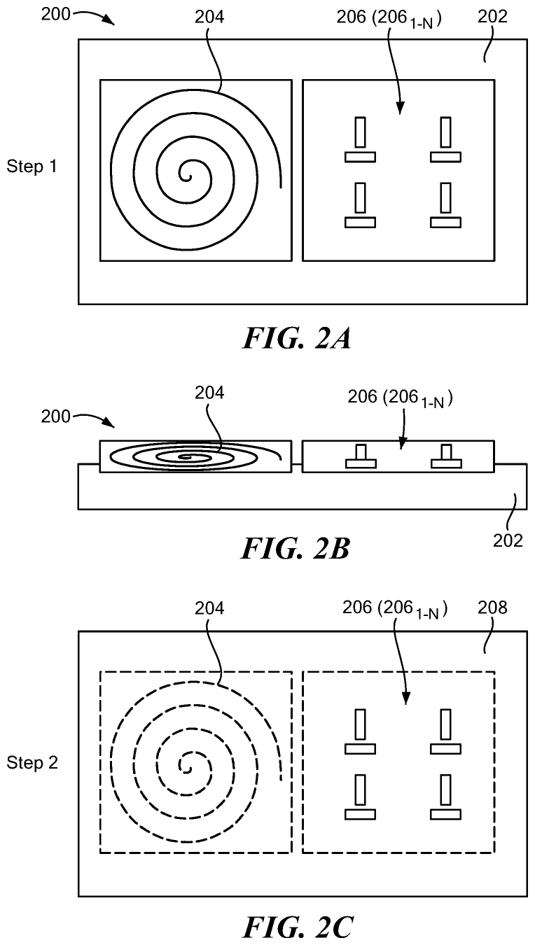

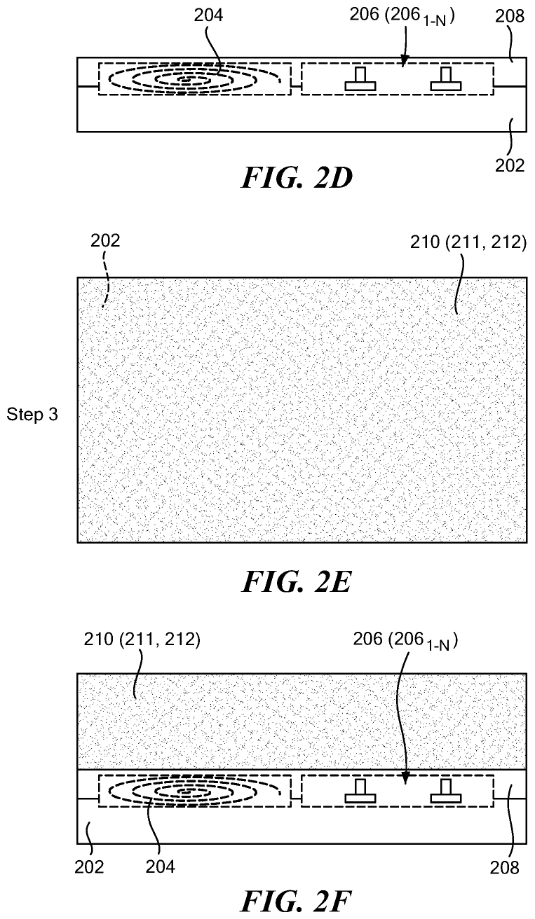

FIGS. 2A-2F show an example variable magnetic coupling touch sensor system 200 utilizing soft ferromagnetic material and a transmit coil used in conjunction with a solid state magnetic field sensing element (e.g., a Hall effect or magnetoresistance element), with corresponding steps of fabrication, in accordance with an embodiment of the present disclosure. FIGS. 2A, 2C, and 2E show top views of successive steps (STEPS 1-3) of fabrication of system 200 and FIGS. 2B, 2D, and 2F show corresponding side views, respectively. System 200 is generally similar to system 100 of FIGS. 1A-1F but utilizes one or more solid state magnetic field sensing elements instead of one or more receive (receiver) coils.

For Step 1, shown in FIGS. 2A-2B, a base system or substrate 202 (e.g., a silicon die, or other substrate), can have a transmission (transmit or send) coil 204 placed on it, and a solid state magnetic field sensing element 206 (e.g., Hall effect element or magnetoresistance element) placed on it as well. As indicated, more than one solid state magnetic field sensing element 206, e.g., a plurality of N elements, can be utilized in some embodiments. When more than one solid state magnetic field sensing element 206 is present, the elements may be configured in any suitable arrangement, e.g., a 1D or 2D array. The transmit coil 204 and solid state magnetic field sensing element 206 can be located adjacent to, e.g., placed on top of, a monitoring circuit/circuitry (not shown) that is designed to monitor the coupling of the coil 204 and the solid state magnetic field sensing element(s) 206.

For Step 2, shown in FIGS. 2C-2D, a protective layer 208 can be applied on top of the coil 204, the solid state magnetic field sensing element 206, and substrate 202 to, e.g., prevent possible harmful interactions of materials.

For Step 3, shown in FIGS. 2E-2F, a mechanically compliant (deformable) material/layer 210 can be applied to the system 200 structure shown at Step 2. The deformable material/layer 210 can include a soft ferromagnetic material 211 (e.g., ferrite in powdered or particulate form, or other suitable materials) that is bound in mechanically compliant material 212 (e.g., a binder).

In operation of system 200, an applied force can cause deformation of deformable layer 210, increasing the density of soft ferromagnetic material in a corresponding region of deformable layer. The change in density can cause a corresponding change in the magnetic coupling between coil 204 and solid state magnetic field sensing element(s) 206. The monitoring circuit/circuitry (not shown) can detect the change in coupling and produce a corresponding output signal for, e.g., determining position and/or magnitude of the applied force.

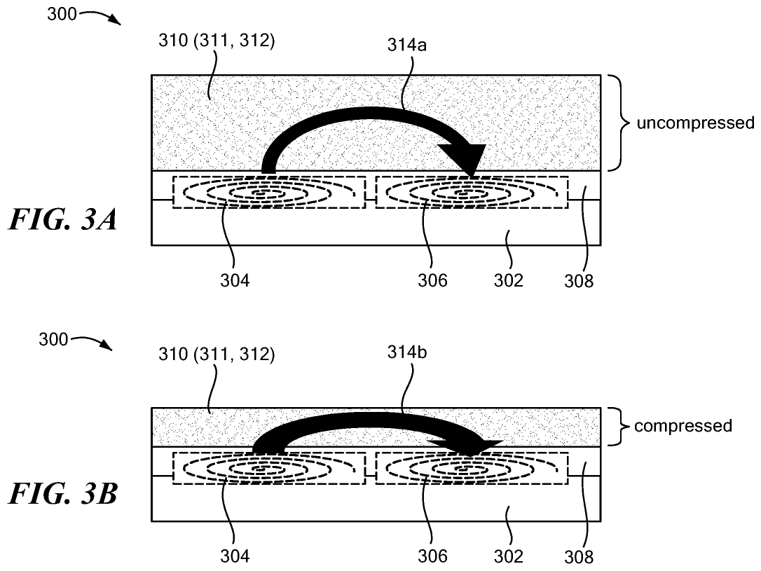

FIGS. 3A-3B show magnetic coupling in an example variable magnetic touch sensor 300 undergoing change due to compression of a binder layer, in accordance with the present disclosure. Variable magnetic touch sensor 300 is similar to system 100 of FIGS. 1A-1F and includes a substrate 302 supporting a transmit (send) coil 304 and a receive coil 306. A protective layer 308 is shown encapsulating substrate 302, transmit coil 304, and receive coil 306. Deformable layer 310 is shown on top of protective layer 308. Deformable layer 310 includes soft ferromagnetic material 311 dispersed in a mechanically compliant material 312, e.g., a binder. In some embodiments, deformable layer 310 can accordingly be referred to as a binder layer.

FIG. 3A shows deformable layer 310 is in an uncompressed state. The magnetic coupling 314a is shown between transmit coil 304 and receive coil 306.

FIG. 3B shows deformable layer 310 in a compressed state, e.g., after application of an applied force/pressure. In the compressed state, the soft ferromagnetic material (e.g., powdered ferrite) dispersed in deformable layer 310 occupies a reduced volume, with a commensurate increase in specific density, thus producing a magnetic coupling 314b between transmit coil 304 and receive coil 306 that is greater than that of FIG. 3A.

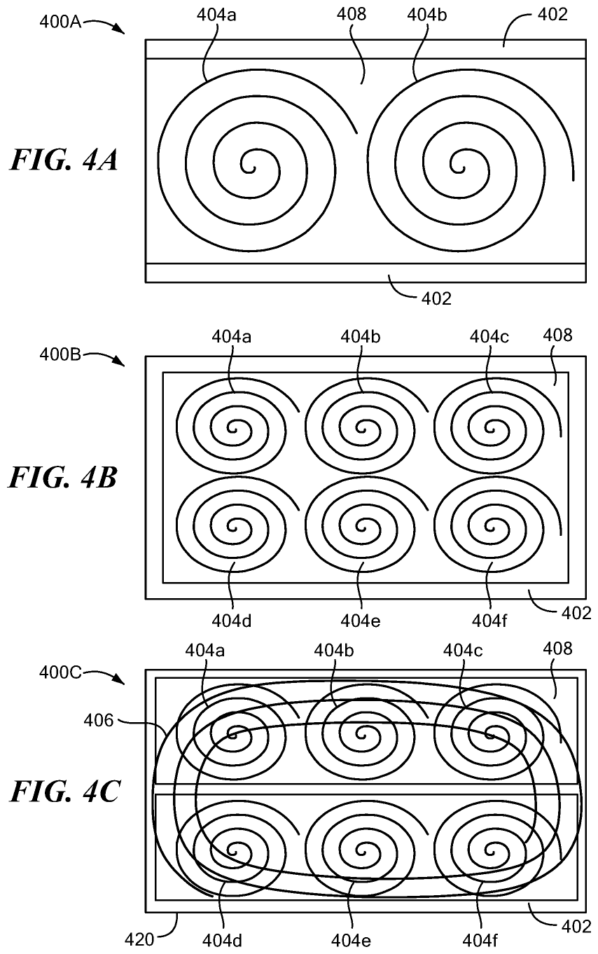

FIGS. 4A-4C show further embodiments 400A-400C having different configurations of receive coils and inclusion of a magnetic core for one embodiment 400C, in accordance with the present disclosure.

FIG. 4A shows an embodiment 400A having a substrate 402 supporting two receive coils 404a-b. Protective layer 408 is disposed on/over receive coils 404a-b and substrate 402. In embodiments utilizing soft ferromagnetic material for the deformable layer (not shown), one or more transmit coils (or suitable transmit antennas) can be included, e.g., as shown and described for FIGS. 1A-2F.

FIG. 4B shows an embodiments 400B similar to embodiment 400A but instead of two receive coils, six receive coils 404a-f are shown configured on substrate 402 as a 2×3 array. A described for embodiment 400A, in embodiments utilizing soft ferromagnetic material for the deformable layer (not shown), one or more transmit coils (or suitable transmit antennas) can be included, e.g., as shown and described for FIGS. 1A-2F.

FIG. 4C shows an embodiment 400C similar to embodiment 400B with an array of six receive coils 404a-f. Embodiment 400C further includes a transmit coil 406 disposed near the perimeter of the array of receive coils 404a-f. Transmit coil 406 is shown as being relatively large compared to the individual receive coils, e.g., 404a. Embodiment 400C further includes a magnetic core 420 configured around the perimeter of the coils 404a-f, 406 to increase magnetic flux per applied current. Magnetic core 420 can include any suitable soft ferromagnetic material. In some embodiments, core 420 may include multiple parts, which may be joined by a suitable material, e.g., ferrite-loaded epoxy.

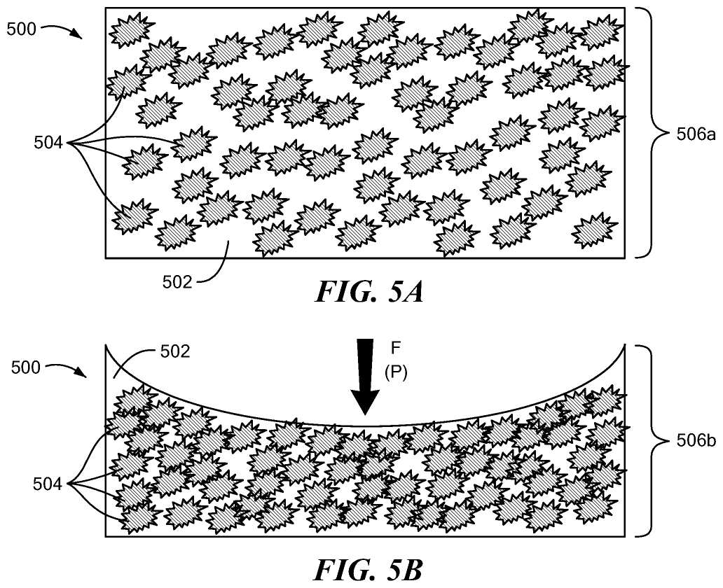

FIGS. 5A-5B show specific density of magnetic particles in a deformable layer 500 of an example variable magnetic coupling touch sensor undergoing change due to compression, in accordance with the present disclosure. Deformable layer 500 includes a bulk mechanically compliant material 502, e.g., a binder such as polyimide, benzocyclobutene (BCB), or silicone gel, etc. Deformable layer 500 also includes ferromagnetic material 504 dispersed throughout its volume. In some embodiments, ferromagnetic material 504 can include soft ferromagnetic material; in some embodiments, ferromagnetic material 504 can include hard ferromagnetic material.

FIG. 5A shows deformable layer 500 in an uncompressed state, indicated by uncompressed height 506a. Ferromagnetic material 504 is shown dispersed throughout the layer 500 and having a first density.

FIG. 5B shows deformable layer 500 in a compressed state, such as would occur in response to an applied force (F) or applied pressure (P), i.e., applied force/area. As shown, as a resulting of the deformation, indicated by compressed height 506b (shown as less than uncompressed height 506a), the density of ferromagnetic material in layer 500 is increased. The increased density can commensurately increase coupling between a magnetic field (from a transmitting coil/antenna or hard ferromagnetic material) and a receive coil or other magnetic field sensing element, e.g., Hall effect element or MR element, for touch sensors in accordance with the present disclosure.

In some embodiments and examples according to the present disclosure, a deformable layer (e.g., binder) can be filled with or include a hard ferromagnetic material and put on a detection system. In some embodiments, the deformable layer (binder) material can be dispensed or screen printed on a detection system. The detection system can be on or in a PCB, in some embodiments. The detection system can be on or in a silicon circuit, in some embodiments. The detection system can be placed directly on the silicon, in some embodiments. The detection system can be placed on or included in an encapsulated silicon die, in some embodiments. The system utilizing hard ferromagnetic material can contain one or many magnetic field sensing elements.

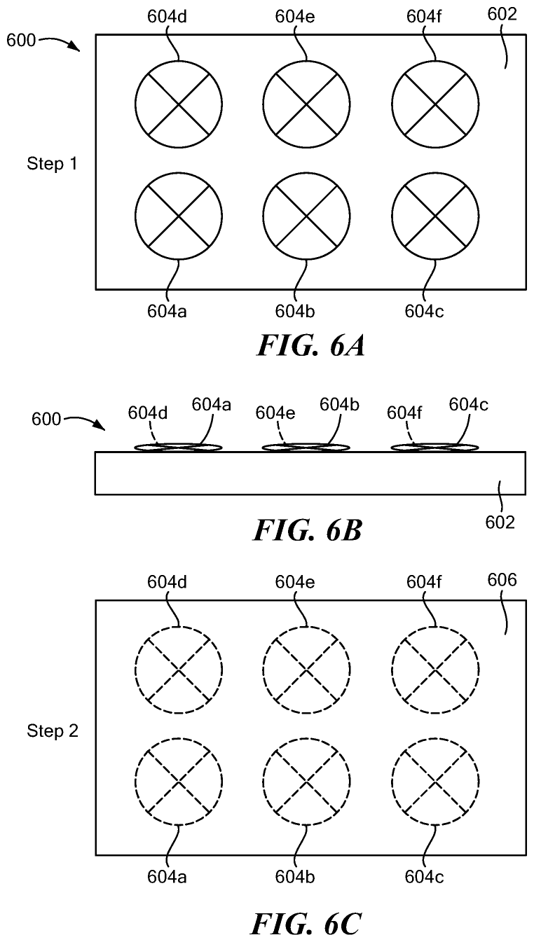

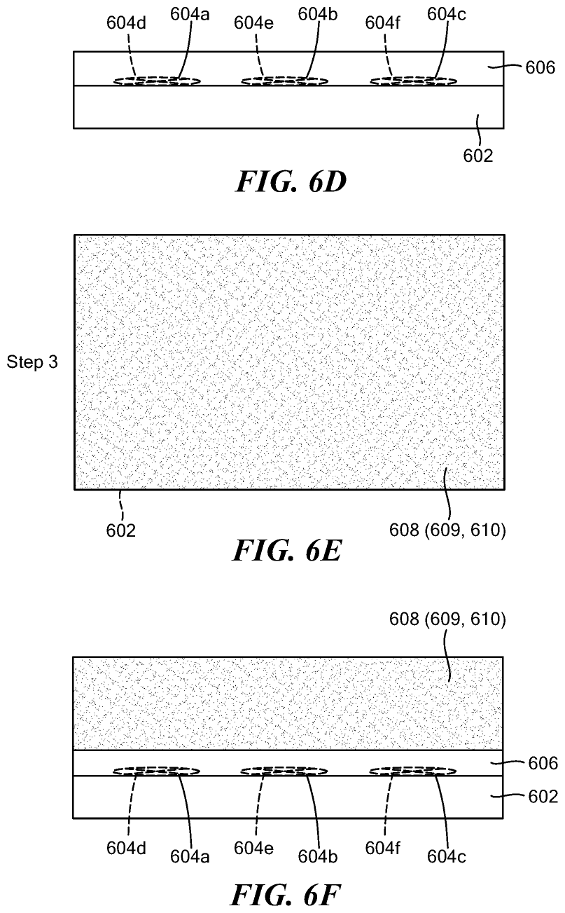

FIGS. 6A-6F show an example variable magnetic coupling touch sensor system 600 utilizing hard ferromagnetic material used in conjunction with a receive coil, with corresponding steps of fabrication, in accordance with an embodiment of the present disclosure. FIGS. 6A, 6C, and 6E show top views of successive steps (Steps 1-3) of fabrication of system 600 and FIGS. 6B, 6D, and 6F show corresponding side views, respectively.

For Step 1, shown in FIGS. 6A-6B, a base system or substrate 602 (e.g., a silicon die, or other substrate), supports one or more magnetic field sensing elements 604, shown as array having elements 604a-f. The magnetic field sensing elements 604a-f can be located adjacent to, e.g., placed on top of, a monitoring circuit (not shown) that is designed to monitor the coupling (field strength) at the magnetic field sensing element(s) 604 (element 604a-f).

For Step 2, shown in FIGS. 6C-6D, a protective layer 606 can be applied on top of the magnetic field sensing elements 604a-f and substrate 602 to, e.g., prevent possible harmful interactions of materials. In some embodiments, protective layer 606 can include Parylene.

For Step 3, shown in FIGS. 6E-6F, a mechanically compliant (deformable) material/layer 608 can be applied to the system 200 structure shown at Step 2. The deformable material/layer 608 can include a hard ferromagnetic material 609 (e.g., ferrite or the like) that is bound in mechanically compliant material 610 (e.g., a binder).

In operation of system 600, an applied force/pressure can cause deformation of deformable layer 608, increasing the density of hard ferromagnetic material 609 in a corresponding region of deformable layer 608, altering the magnetic coupling between hard ferromagnetic material 609 and the magnetic field sensing elements 604a-f or altering the field strength at elements 604a-f. The monitoring circuit (not shown) can detect the change in magnetic coupling or field strength and produce a corresponding output signal (indicative of the deformation of deformable layer 608), which can be used to determine a magnitude and/or location of the applied force/pressure.

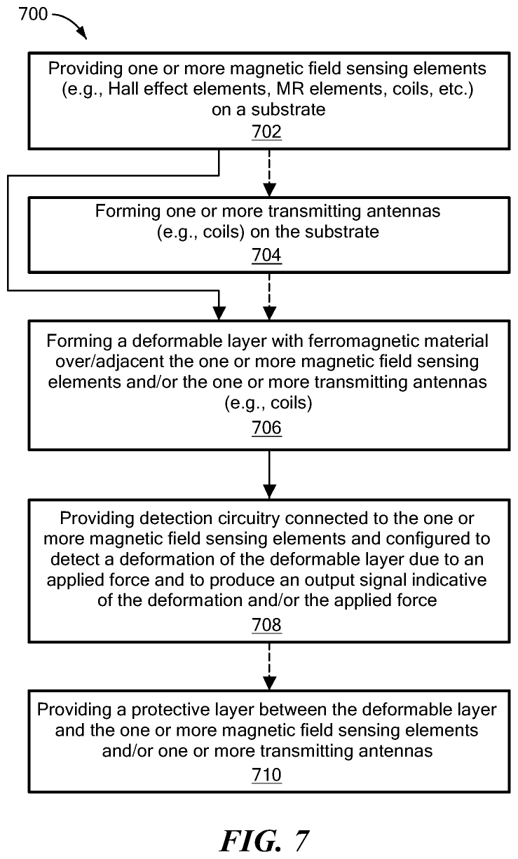

FIG. 7 is a diagram showing steps in an example method 700 of making variable magnetic coupling touch sensors, in accordance with the present disclosure. One or more magnetic field sensing elements (e.g., Hall effect elements, MR elements, coils, etc.) can be provided on/for a substrate, as described at 702. One or more transmitting antennas (e.g., coils) can be provided on/for the substrate, as described at 704. A deformable layer with ferromagnetic material can be formed over/adjacent to the one or more magnetic field sensing elements and/or the one or more transmitting antennas (e.g., coils), as described at 706. In some embodiments, the ferromagnetic material can include soft ferromagnetic material. In some embodiments, the ferromagnetic material can include hard ferromagnetic material. Detection circuitry can be provided that is configured (e.g., connected to) relative to the one or more magnetic field sensing elements and configured to detect a deformation of the deformable layer and to produce an output signal indicative of the deformation, as described at 708. A protective layer can be formed/provided between the deformable layer and the one or more magnetic field sensing elements and/or one or more transmitting antennas, as described at 710.

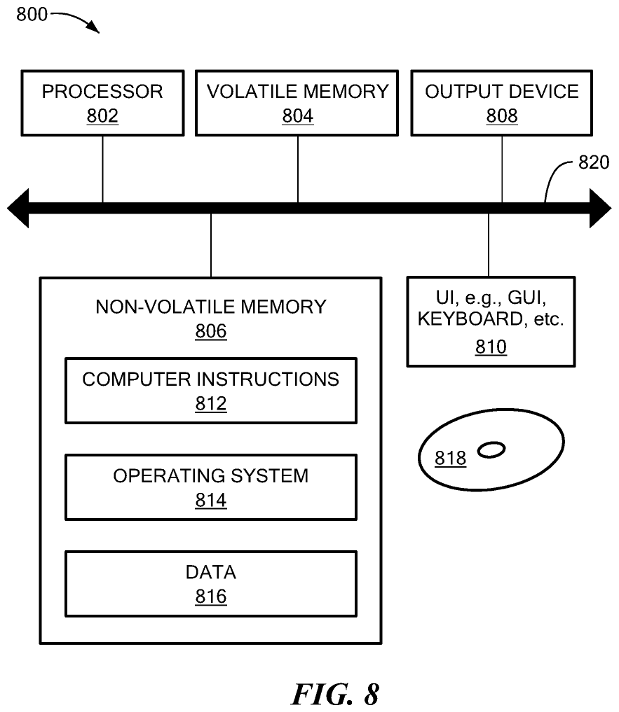

FIG. 8 is a schematic diagram of an example computer system 800 that can perform all or at least a portion of the processing, e.g., steps in the algorithms and methods, including determination of magnitude, direction, temperature, time (duration) and/or location of or associated with an applied force and/or pressure, as described herein. The computer system 800 can includes a processor 802, a volatile memory 804, a non-volatile memory 806 (e.g., hard disk), an output device 808 and a user input or interface (UI) 810, e.g., graphical user interface (GUI), a mouse, a keyboard, a display, and/or any common user interface, etc. The non-volatile memory (non-transitory storage medium) 806 stores computer instructions 812 (a.k.a., machine-readable instructions or computer-readable instructions) such as software (computer program product), an operating system 814 and data 816. In one example, the computer instructions 812 are executed by the processor 802 out of (from) volatile memory 804. In one embodiment, an article/apparatus 818 (e.g., a storage device or medium such as a hard disk, an optical disc, magnetic storage tape, optical storage tape, flash drive, etc.) includes or stores the non-transitory computer-readable instructions.

Processing may be implemented in hardware, software, or a combination of the two. Processing may be implemented in computer programs executed on programmable computers/machines that each includes a processor, a storage medium or other article of manufacture that is readable by the processor (including volatile and non-volatile memory and/or storage elements), and optionally at least one input device, and one or more output devices. Program code may be applied to data entered using an input device or input connection (e.g., port or bus) to perform processing and to generate output information.

The system 800 can perform processing, at least in part, via a computer program product, (e.g., in a machine-readable storage device), for execution by, or to control the operation of, data processing apparatus (e.g., a programmable processor, a computer, or multiple computers). Each such program may be implemented in a high-level procedural or object-oriented programming language to communicate with a computer system. However, the programs may be implemented in assembly or machine language. The language may be a compiled or an interpreted language and it may be deployed in any form, including as a stand-alone program or as a module, component, subroutine, or other unit suitable for use in a computing environment. A computer program may be deployed to be executed on one computer or on multiple computers at one site or distributed across multiple sites and interconnected by a communication network. A computer program may be stored on a storage medium or device (e.g., CD-ROM, hard disk, or magnetic diskette) that is readable by a general or special purpose programmable computer for configuring and operating the computer when the storage medium or device is read by the computer. Processing may also be implemented as a machine-readable storage medium, configured with a computer program, where upon execution, instructions in the computer program cause the computer to operate.

Processing may be performed by one or more programmable processors executing one or more computer programs to perform the functions of the system. All or part of the system may be implemented as special purpose logic circuitry, e.g., an FPGA (field programmable gate array) and/or an ASIC (application-specific integrated circuit).

Accordingly, embodiments of the inventive subject matter can afford various benefits relative to prior art techniques. For example, embodiments and examples of the present disclosure can provide accurate and readily fabricated touch sensing functionality for integrated circuits (ICs), semiconductor (IC) die, and/or packages including IC die, e.g., transformer based galvanically isolated gate drivers or other high voltage circuits.

Various embodiments of the concepts, systems, devices, structures, and techniques sought to be protected are described above with reference to the related drawings. Alternative embodiments can be devised without departing from the scope of the concepts, systems, devices, structures, and techniques described. For example, while transmitting coils have been described herein for some embodiments of the present disclosure, other embodiments (such as ones applying a varying magnetic field) can include transmitting antenna of various suitable geometries and constructions, e.g., dipoles, monopoles, etc.

It is noted that various connections and positional relationships (e.g., over, below, adjacent, etc.) may be used to describe elements and components in the description and drawings. These connections and/or positional relationships, unless specified otherwise, can be direct or indirect, and the described concepts, systems, devices, structures, and techniques are not intended to be limiting in this respect. Accordingly, a coupling of entities can refer to either a direct or an indirect coupling, and a positional relationship between entities can be a direct or indirect positional relationship.

As an example of an indirect positional relationship, positioning element “A” over element “B” can include situations in which one or more intermediate elements (e.g., element “C”) is between elements “A” and elements “B” as long as the relevant characteristics and functionalities of elements “A” and “B” are not substantially changed by the intermediate element(s).

Also, the following definitions and abbreviations are to be used for the interpretation of the claims and the specification. The terms “comprise,” “comprises,” “comprising,” “include,” “includes,” “including,” “has,” “having,” “contains” or “containing,” or any other variation are intended to cover a non-exclusive inclusion. For example, an apparatus, a method, a composition, a mixture, or an article, which includes a list of elements is not necessarily limited to only those elements but can include other elements not expressly listed or inherent to such apparatus, method, composition, mixture, or article.

Additionally, the term “exemplary” means “serving as an example, instance, or illustration. Any embodiment or design described as “exemplary” is not necessarily to be construed as preferred or advantageous over other embodiments or designs. The terms “one or more” and “at least one” indicate any integer number greater than or equal to one, i.e., one, two, three, four, etc.; though, where context admits, those terms may indicate fractional values. The term “plurality” indicates any integer or fractional number greater than one. The term “connection” can include an indirect “connection” and a direct “connection.”

References in the specification to “embodiments,” “one embodiment, “an embodiment,” “an example embodiment,” “an example,” “an instance,” “an aspect,” etc., indicate that the embodiment described can include a particular feature, structure, or characteristic, but every embodiment may or may not include the particular feature, structure, or characteristic. Moreover, such phrases do not necessarily refer to the same embodiment. Further, when a particular feature, structure, or characteristic is described in connection with an embodiment, it may affect such feature, structure, or characteristic in other embodiments whether explicitly described or not.

Relative or positional terms including, but not limited to, the terms “upper,” “lower,” “right,” “left,” “vertical,” “horizontal, “top,” “bottom,” and derivatives of those terms relate to the described structures and methods as oriented in the drawing figures. The terms “overlying,” “atop,” “on top, “positioned on” or “positioned atop” mean that a first element, such as a first structure, is present on a second element, such as a second structure, where intervening elements such as an interface structure can be present between the first element and the second element. The term “direct contact” means that a first element, such as a first structure, and a second element, such as a second structure, are connected without any intermediary elements.

Use of ordinal terms such as “first,” “second,” “third,” etc., in the claims to modify a claim element does not by itself connote any priority, precedence, or order of one claim element over another, or a temporal order in which acts of a method are performed, but are used merely as labels to distinguish one claim element having a certain name from another element having a same name (but for use of the ordinal term) to distinguish the claim elements.

The terms “approximately” and “about” may be used to mean within ±20% of a target (or nominal) value in some embodiments, within plus or minus (±) 10% of a target value in some embodiments, within ±5% of a target value in some embodiments, and yet within ±2% of a target value in some embodiments. The terms “approximately” and “about” may include the target value. The term “substantially equal” may be used to refer to values that are within ±20% of one another in some embodiments, within ±10% of one another in some embodiments, within ±5% of one another in some embodiments, and yet within ±2% of one another in some embodiments.

The term “substantially” may be used to refer to values that are within ±20% of a comparative measure in some embodiments, within ±10% in some embodiments, within ±5% in some embodiments, and yet within ±2% in some embodiments. For example, a first direction that is “substantially” perpendicular to a second direction may refer to a first direction that is within ±20% of making a 90° angle with the second direction in some embodiments, within ±10% of making a 90° angle with the second direction in some embodiments, within ±5% of making a 90° angle with the second direction in some embodiments, and yet within ±2% of making a 90° angle with the second direction in some embodiments.

The disclosed subject matter is not limited in its application to the details of construction and to the arrangements of the components set forth in the following description or illustrated in the drawings. The disclosed subject matter is capable of other embodiments and of being practiced and carried out in various ways.

Also, the phraseology and terminology used in this patent are for the purpose of description and should not be regarded as limiting. As such, the conception upon which this disclosure is based may readily be utilized as a basis for the designing of other structures, methods, and systems for carrying out the several purposes of the disclosed subject matter. Therefore, the claims should be regarded as including such equivalent constructions as far as they do not depart from the spirit and scope of the disclosed subject matter.

Although the disclosed subject matter has been described and illustrated in the foregoing exemplary embodiments, the present disclosure has been made only by way of example. Thus, numerous changes in the details of implementation of the disclosed subject matter may be made without departing from the spirit and scope of the disclosed subject matter.

Accordingly, the scope of this patent should not be limited to the described implementations but rather should be limited only by the spirit and scope of the following claims.

All publications and references cited in this patent are expressly incorporated by reference in their entirety.

What is claimed is:

1. A magnetic touch sensor comprising:
one or more transmitting coils disposed on a substrate and configured to transmit a signal;
one or more magnetic field sensing elements disposed on the substrate and configured to receive the signal from the one or more transmitting coils;
a deformable layer containing soft ferromagnetic material, wherein the deformable layer is adjacent to the one or more magnetic field sensing elements, wherein deformable layer is configured to facilitate magnetic coupling between the one or more transmitting coils and the one or more magnetic field sensing elements, and wherein the deformable layer is mechanically compliant and configured to undergo a deformation in response to an applied force; and
detection circuitry connected to the one or more magnetic field sensing elements and configured to detect a change in the signal in response to the deformation of the deformable layer, wherein the detection circuitry is configured to produce an output signal indicative of the deformation of the deformable layer.

2. The magnetic touch sensor of claim 1, wherein the substrate comprises a semiconductor die.

3. The magnetic touch sensor of claim 2, further comprising an integrated circuit disposed in the semiconductor die, and wherein the integrated circuit comprises the detection circuitry.

4. The magnetic touch sensor of claim 1, wherein the substrate comprises a printed circuit board (PCB).

5. The magnetic touch sensor of claim 1, wherein the soft ferromagnetic material is dispersed in the deformable layer.

6. The magnetic touch sensor of claim 5, wherein the deformable layer has a plurality of regions and wherein the soft ferromagnetic material is dispersed with different respective concentrations in the plurality of regions.

7. The magnetic touch sensor of claim 1, wherein the output signal is indicative of a location associated with the applied force.

8. The magnetic touch sensor of claim 1, wherein the output signal is indicative of a direction associated with the applied force.

9. The magnetic touch sensor of claim 1, wherein the output signal is indicative of a magnitude associated with the applied force.

10. The magnetic touch sensor of claim 1, wherein the output signal is indicative of a time associated with the applied force.

11. The magnetic touch sensor of claim 1, wherein the output signal is indicative of a temperature associated with the applied force.

12. The magnetic touch sensor of claim 1, wherein the output signal is indicative of a pressure applied to the deformable layer.

13. The magnetic touch sensor of claim 1, wherein the output signal is indicative of a displacement of the deformable layer.

14. The magnetic touch sensor of claim 13, wherein the output signal is indicative of a location associated with the displacement of the deformable layer.

15. The magnetic touch sensor of claim 1, wherein the one or more transmitting coils are disposed adjacent to one or more magnetic field sensing elements.

16. The magnetic touch sensor of claim 1, wherein the one or more magnetic field sensing elements comprise a first plurality of receiving coils.

17. The magnetic touch sensor of claim 16, wherein the one or more transmitting coils comprise a first transmitting coil larger in size than an individual receiving coil of the first plurality of receiving coils, and wherein the first plurality of receiving coils is disposed on the substrate within an area of the first transmitting coil.

18. The magnetic touch sensor of claim 17, further comprising a second plurality of receiving coils disposed around the area of the first transmitting coil.

19. The magnetic touch sensor of claim 1, wherein the one or more magnetic field sensing elements comprise a plurality of Hall effect elements.

20. The magnetic touch sensor of claim 1, wherein the one or more magnetic field sensing elements comprise a plurality of magnetoresistance (MR) elements.

21. The magnetic touch sensor of claim 20, wherein the plurality of MR elements comprise giant magnetoresistance (GMR) elements.

22. The magnetic touch sensor of claim 20, wherein the plurality of MR elements comprise tunneling magnetoresistance (TMR) elements.

23. The magnetic touch sensor of claim 1, wherein the deformable layer comprises polyimide.

24. The magnetic touch sensor of claim 1, wherein the deformable layer comprises benzocyclobutene (BCB).

25. The magnetic touch sensor of claim 1, wherein the deformable layer comprises silicone gel.

26. The magnetic touch sensor of claim 1, further comprising a protective layer disposed between (i) the one or more transmitting coils and/or one or more magnetic field sensing elements, and (ii) the deformable layer.

27. The magnetic touch sensor of claim 26, wherein the protective layer comprises Parylene.

28. The magnetic touch sensor of claim 1, wherein the soft ferromagnetic material comprises ferrite particles.

29. The magnetic touch sensor of claim 16, further comprising a magnetic core disposed adjacent the one or more transmitting coils and/or the first plurality of receiving coils to facilitate magnetic coupling between the one or more transmitting coils and the first plurality of receiving coils.

30. A magnetic touch sensor comprising:
one or more magnetic field sensing elements disposed on a substrate;
a deformable layer disposed adjacent to the one or more magnetic field sensing elements, wherein the deformable layer includes a hard ferromagnetic material, wherein the deformable layer is mechanically compliant and configured to undergo a deformation in response to an applied force, and wherein the deformable layer is configured to produce a changing magnetic field in response to the deformation; and
detection circuitry connected to the one or more magnetic field sensing elements and configured to detect the changing magnetic field at the one or more magnetic field sensing elements and produce an output signal, wherein the output signal is indicative of the deformation of the deformable layer.

31. The magnetic touch sensor of claim 30, wherein the substrate comprises a semiconductor die.

32. The magnetic touch sensor of claim 31, further comprising an integrated circuit disposed in the semiconductor die, and wherein the integrated circuit comprises the detection circuitry.

33. The magnetic touch sensor of claim 30, wherein the substrate comprises a printed circuit board (PCB).

34. The magnetic touch sensor of claim 30, wherein the hard ferromagnetic material is dispersed in the deformable layer.

35. The magnetic touch sensor of claim 34, wherein the deformable layer has a plurality of regions and wherein the hard ferromagnetic material is dispersed with different respective concentrations in the plurality of regions.

36. The magnetic touch sensor of claim 30, wherein the output signal is indicative of a location associated with the applied force.

37. The magnetic touch sensor of claim 30, wherein the output signal is indicative of a direction associated with the applied force.

38. The magnetic touch sensor of claim 30, wherein the output signal is indicative of a magnitude associated with the applied force.

39. The magnetic touch sensor of claim 30, wherein the output signal is indicative of a temperature or time associated with the applied force.

40. The magnetic touch sensor of claim 30, wherein the output signal is indicative of a pressure applied to the deformable layer.

41. The magnetic touch sensor of claim 30, wherein the output signal is indicative of a displacement of the deformable layer.

42. The magnetic touch sensor of claim 41, wherein the output signal is indicative of a location associated with the displacement of the deformable layer.

43. The magnetic touch sensor of claim 30, wherein the one or more magnetic field sensing elements comprise a plurality of receiving coils.

44. The magnetic touch sensor of claim 30, wherein the one or more magnetic field sensing elements comprise a plurality of Hall effect elements.

45. The magnetic touch sensor of claim 30, wherein the one or more magnetic field sensing elements comprise a plurality of magnetoresistance (MR) elements.

46. The magnetic touch sensor of claim 45, wherein the plurality of MR elements comprise giant magnetoresistance (GMR) elements.

47. The magnetic touch sensor of claim 45, wherein the plurality of MR elements comprise tunneling magnetoresistance (TMR) elements.

48. The magnetic touch sensor of claim 30, wherein the deformable layer comprises polyimide.

49. The magnetic touch sensor of claim 30, wherein the deformable layer comprises benzocyclobutene (BCB).

50. The magnetic touch sensor of claim 30, wherein the deformable layer comprises silicone gel.

51. The magnetic touch sensor of claim 30, further comprising a protective layer disposed between the one or more magnetic field sensing elements and the deformable layer.

52. The magnetic touch sensor of claim 51, wherein the protective layer comprises Parylene.

53. The magnetic touch sensor of claim 30, wherein the hard ferromagnetic material comprises ferrite particles.

54. A method of making a magnetic touch sensor, the method comprising:
providing one or more magnetic field sensing elements on a substrate;
forming a deformable layer adjacent the one or more magnetic field sensing elements, wherein the deformable layer includes ferromagnetic material, and wherein the deformable layer is mechanically compliant and configured to undergo a deformation in response to an applied force, and wherein the deformable layer is configured to produce a changing magnetic field in response to the deformation; and
providing detection circuitry configured to detect the changing magnetic field and produce an output signal indicative of the deformation of the deformable layer.

55. The method of claim 54, wherein the ferromagnetic material comprises a hard ferromagnetic material.

56. The method of claim 54, further comprising forming one or more transmitting antennas on the substrate, wherein the one or more transmitting antennas are configured to transmit a signal, and wherein the one or more magnetic field sensing elements are configured to receive the signal.

57. The method of claim 56, wherein the ferromagnetic material comprises a soft ferromagnetic material.

58. The method of claim 54, further comprising providing a protective layer between the substrate and the deformable layer, wherein the protective layer is configured to protect the one or more magnetic field sensing elements.

59. The method of claim 54, wherein the one or more magnetic field sensing elements comprise a plurality of Hall effect elements.

60. The method of claim 54, wherein the one or more magnetic field sensing elements comprise a plurality of magnetoresistance (MR) elements.

61. The method of claim 60, wherein the plurality of MR elements comprise giant magnetoresistance (GMR) elements.

62. The method of claim 60, wherein the plurality of MR elements comprise tunneling magnetoresistance (TMR) elements.

63. The method of claim 56, wherein the one or more transmitting antennas comprise one or more coils.
